(19) United States
(12) Patent Application Publication
(10) Pub. No.: US 2015/0373735 A1
(43) Pub. Date: Dec. 24, 2015

(54) TOPOLOGY-INDEPENDENT DISSEMINATION OF ALARM DATA ABOVE NETWORK PRIORITY

(71) Applicant: Cisco Technology, Inc., San Jose, CA (US)

(72) Inventors: PASCAL THUBERT, La Colle Sur Loup (FR); JEAN-PHILIPPE VASSEUR, Saint Martin d'Uriage (FR); PATRICK WETTERWALD, Mouans Sartoux (FR); JONATHAN WING-YAN HUI, Belmont, CA (US)

(21) Appl. No.: 14/309,077

(22) Filed: Jun. 19, 2014

(51) Int. Cl. H04W 72/12

(52) U.S. Cl. CPC H04W 72/12; H04W 84/18

(57) ABSTRACT

In one embodiment, a method comprises receiving, by a network device, a data packet specifying alarm data generated by a sensor node; and outputting, by the network device, the data packet at an alarm level priority that is higher than any network-level priority of any wireless routing topology.

### TECHNICAL FIELD

The present disclosure generally relates to wireless ad hoc sensor networks that send data packets to a destination, for example alarm packets.

### BACKGROUND

This section describes approaches that could be employed, but are not necessarily approaches that have been previously conceived or employed. Hence, unless explicitly specified otherwise, any approaches described in this section are not prior art to the claims in this application, and any approaches described in this section are not admitted to be prior art by inclusion in this section.

The Internet Engineering Task Force (IETF) has proposed techniques for routing data packets via routes created over a determined network topology in “Low power and Lossy Networks” (LLNs) having network devices with limited resources in communication, computation, memory, and/or energy. One example technique is described in RFC 6550, entitled “RPL: IPv6 Routing Protocol for Low-Power and Lossy Networks”. Another example technique is described in RFC 6206, entitled “The Trickle Algorithm”. Another example technique employing RFC 6206 is the Internet Draft by Hui et al, “Multicast Protocol for Low power and Lossy Networks (MPL): draft-ietf-roll-trickle-mcast-05”. A disruption in the network topology requires a recalculation of routes, causing a delay in the propagation of data packets over the network.

### BRIEF DESCRIPTION OF THE DRAWINGS

Reference is made to the attached drawings, wherein elements having the same reference numeral designations represent like elements throughout and wherein:

FIGS. 1A and 1B illustrate an example system having an apparatus for outputting alarm data at an alarm level priority that is higher than any network-level priority of any wireless routing topology, according to an example embodiment.

FIG. 2 illustrates an example apparatus for outputting alarm data at an alarm level priority that is higher than any network-level priority of any wireless routing topology, according to an example embodiment.

FIG. 3 illustrates an example method in the network device of FIG. 1 for outputting alarm data at an alarm level priority that is higher than any network-level priority of any wireless routing topology, according to an example embodiment.

FIG. 4 illustrates an example outputting the alarm data based on waiting a waiting interval of a random selected time interval to detect if the alarm data has already been transmitted a prescribed number of times, according to an example embodiment.

### DESCRIPTION OF EXAMPLE EMBODIMENTS

### Overview

In one embodiment, a method comprises: receiving, by a network device, a data packet specifying alarm data generated by a sensor node; and outputting, by the network device, the data packet at an alarm level priority that is higher than any network-level priority of any wireless routing topology.

In another embodiment, an apparatus comprises a device interface circuit, and a processor circuit. The device interface circuit is configured for receiving a data packet specifying alarm data generated by a sensor node. The processor circuit is configured for controlling outputting of the data packet at an alarm level priority that is higher than any network-level priority of any wireless routing topology.

In yet another embodiment, logic is encoded in one or more non-transitory tangible media for execution by a machine and when executed by the machine operable for: receiving a data packet specifying alarm data generated by a sensor node; and outputting the data packet at an alarm level priority that is higher than any network-level priority of any wireless routing topology.

### DETAILED DESCRIPTION

Existing wireless networks assume that a wireless network topology (e.g., according to RPL) can be established in a mesh network of wireless network nodes to forward sensor data to a destination designated as a root of a tree-based topology. However, a critical event such as explosion, flood, or fire can cause a disruption or complete loss of the wireless network topology, for example due to destruction of a substantial number of the wireless network nodes in the mesh network. Existing wireless protocols invariably respond to the disruption by attempting to repair the damaged wireless network topology using routing protocol messages designated to have a “network priority” that is higher than any other data packets carrying sensor data; hence, propagation of the sensor data is suppressed until the wireless network topology is repaired (i.e., network convergence is completed). Depending on the size and density of the wireless network, network convergence may not be completed for minutes to hours. Hence, the priority normally placed on repairing a wireless network topology can result in an unfortunate delay in transmission of critical alarm data until network convergence has been completed, even though the alarm data may be needed urgently to control damage from the critical event and save human lives.

Particular embodiments enable propagation of alarm data to a wired destination via a plurality of wireless network nodes based on disseminating the alarm data at an alarm level priority that is higher than any network-level priority of any wireless routing topology, without the necessity of any wireless routing topology between any of the wireless network nodes. The dissemination of the alarm data at the alarm level priority (higher than any network-level priority) can enable the alarm data (i.e., alert data) to be delivered to the wired destination even though a critical event has damaged the wireless network topology.

In particular, upon a critical event causing damage to a wireless network topology, operational data from various sensors can be critical to save lives and control damage from the critical event. Contrary to granting network operations (e.g., management, routing, etc.) the highest priority, the example embodiments grant highest priority to the alarm data, enabling the alarm data to be propagated among available network devices remaining after the critical event; hence, the alarm data can reach a wired destination (for delivery to an emergency operations center) on the order of seconds, without waiting for network convergence to repair the damaged wireless network topology.

Further, any network device receiving a data packet specifying the alarm data can suspend use of any wireless routing protocol and/or any wireless routing topology in response to the alarm data, and output the data packet at the alarm level priority that is higher than any network-level priority of any wireless routing topology. Hence, a network device can respond to the alarm data without the need for determining the expiration of any timers with respect to heartbeat messages (indicating the loss of a neighboring or remote network device) or keepalive messages (indicating a loss of a data link). Consequently, a network device operating under a conventional routing protocol (e.g., RPL) can respond to the unanticipated alarm data by suppressing transmission of any network-level priority data packet, transmitting at alarm level priority the data packet specifying the alarm data, and resuming routing operations (including transmitting any network-level priority data packet to begin network repair) after transmission of the data packet specifying the alarm data. The term “network-level priority” as used in the specification and attached claims is defined as the highest level priority (i.e., highest class of service) normally defined in a multiple-priority Quality of Service (QoS) scheme, where the network-level priority is normally reserved exclusively for establishment and/or maintenance of a routing topology in a data network: example implementations of network-level priority can include setting a 3-bit Priority Code Point (PCP) value to “7” (representing “Network Control”) in an IEEE 802.Q header, Differentiated Services Code Point (DSCP) value “56” (decimal) representing “CS7” per RFC 2474, IP Precedence value of “7” representing “Network Control” according to RFC 791, etc.

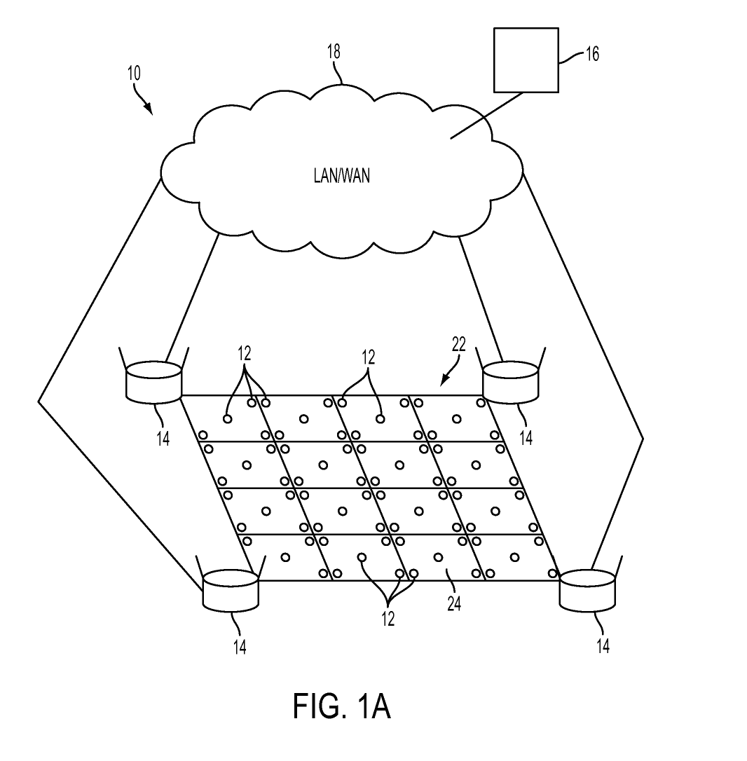

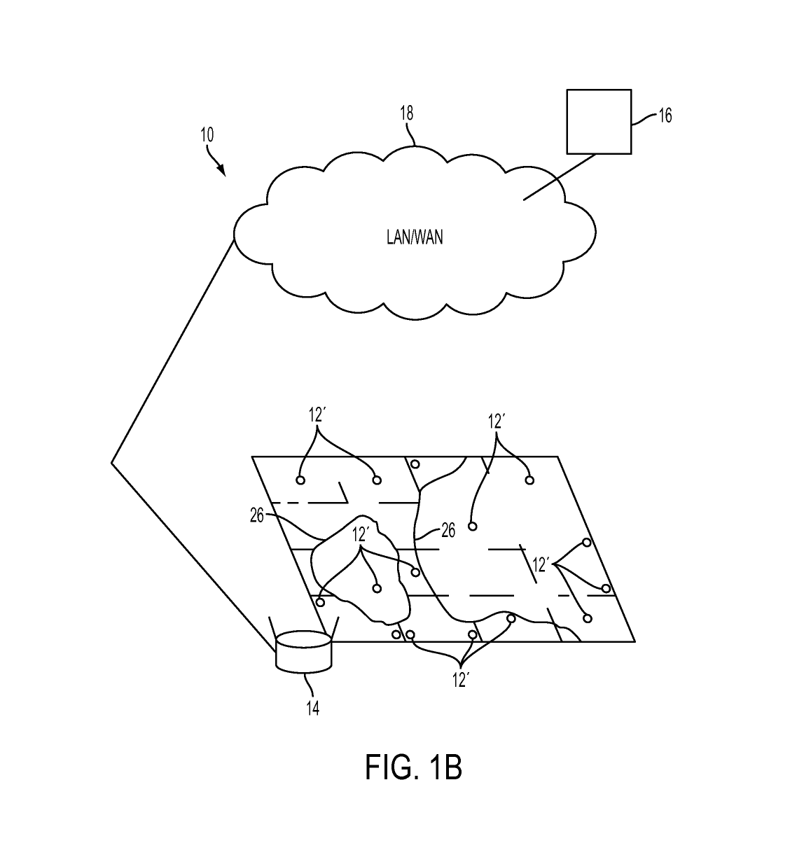

FIG. 1A is a diagram illustrating an example network 10 having numerous network devices 12 for forwarding alarm data generated by a sensor node, according to an example embodiment. The network 10 also can include one or more wired destination devices 14 for sending sensor data to one or more host network devices 16 via a local area network and/or a wide area network 18. Each apparatus 12, 14, and 16 is a physical machine (i.e., a hardware device) configured for implementing network communications with other physical machines via a wired or wireless data network. The term “configured for” as used herein with respect to a specified operation refers to a device that is physically constructed and arranged to perform the specified operation.

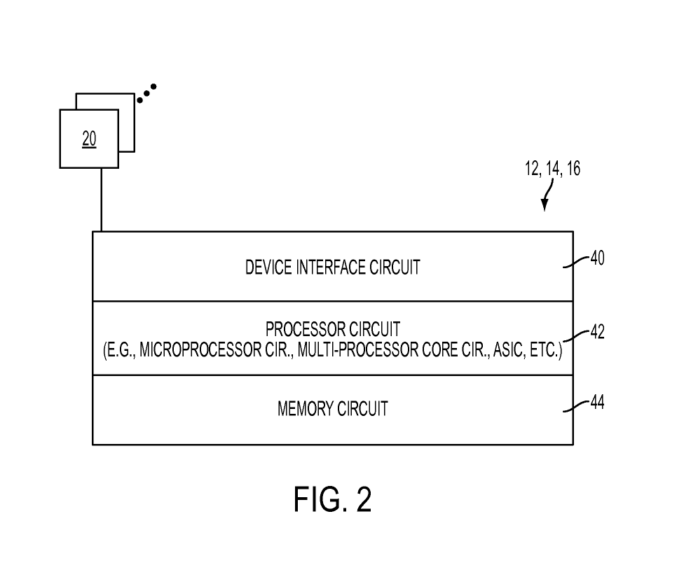

Each network device 12 can be implemented as a wireless sensor node having one or more attached physical sensors (20 of FIG. 2), and/or a wireless forwarding node that can forward received data packets according to a prescribed wireless routing protocol, for example RPL. As used herein, the term “sensor node” refers to a wireless network device that is originating a data packet containing sensor data (e.g., “normal sensor data”, “alarm data” representing sensor data exceeding prescribed thresholds, etc.). A “forwarding node” refers to a wireless network device that can receive a data packet from another network device, and that can output the received data packet via a wireless data link to another network device 12 and/or 14. Hence, a network device 12 can operate as a sensor node and/or a forwarding node (i.e., a wireless sensor node can be configured, constructed and arranged to forward data packets received from another network device).

As illustrated in FIG. 1A, a large number of network devices 12 are distributed about a prescribed region 22, where the prescribed region 22 can be subdivided into identifiable locations 24. For example, the prescribed region 22 can be a layout of a factory floor of a manufacturing facility for hazardous materials, for example a site having wireless sensors for monitoring activities according to Seveso Directives II and/or Seveso III; hence, the identifiable locations 24 can be identifiable grids of the factory floor; the prescribed region 22 also can be a floor of a building of a manufacturing facility, research facility, etc., where the identifiable locations 24 can be separate rooms, etc. As illustrated in FIG. 1A, the network devices 12 during normal operations can establish a wireless network topology (e.g., according to RPL) overlying a wireless mesh network, and route wireless data packets to any one of the destination wired routers for network-based communications with a prescribed destination (e.g., 16) via the LAN/WAN 18. Further, the density of network devices 12 can ensure that numerous paths are available within the network topology to reach one or more of the wired destination devices 14.

FIG. 1B illustrates the prescribed region 22 of FIG. 1A after having experienced a disaster such as an explosion, fire, terrorist attack, etc., where a substantial number of the network devices 12 have been destroyed by the disaster, resulting in a disruption or complete loss of the wireless network topology. As illustrated in FIG. 1B, the remaining network devices 12′ have a substantially lower density of network devices within the prescribed region 22, resulting in a substantially lower likelihood of reliable wireless data links between the remaining network devices 12′. Hence, the remaining network devices 12′ are incapable of establishing a new wireless network topology without initiating network convergence; moreover, the substantially lower density of wireless network devices 12′ (and debris “walls” 26 caused by the disaster) results in more unreliable data links between the remaining network devices 12′, further increasing the time to complete convergence to reach the sole remaining wired destination device 14′.

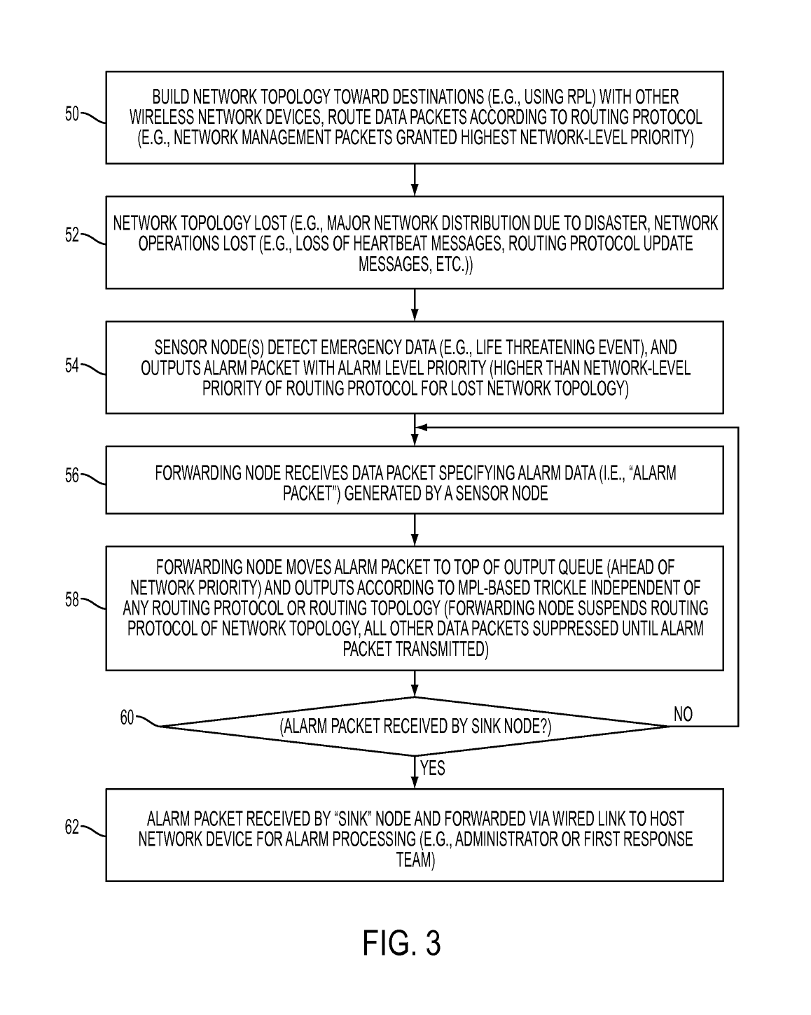

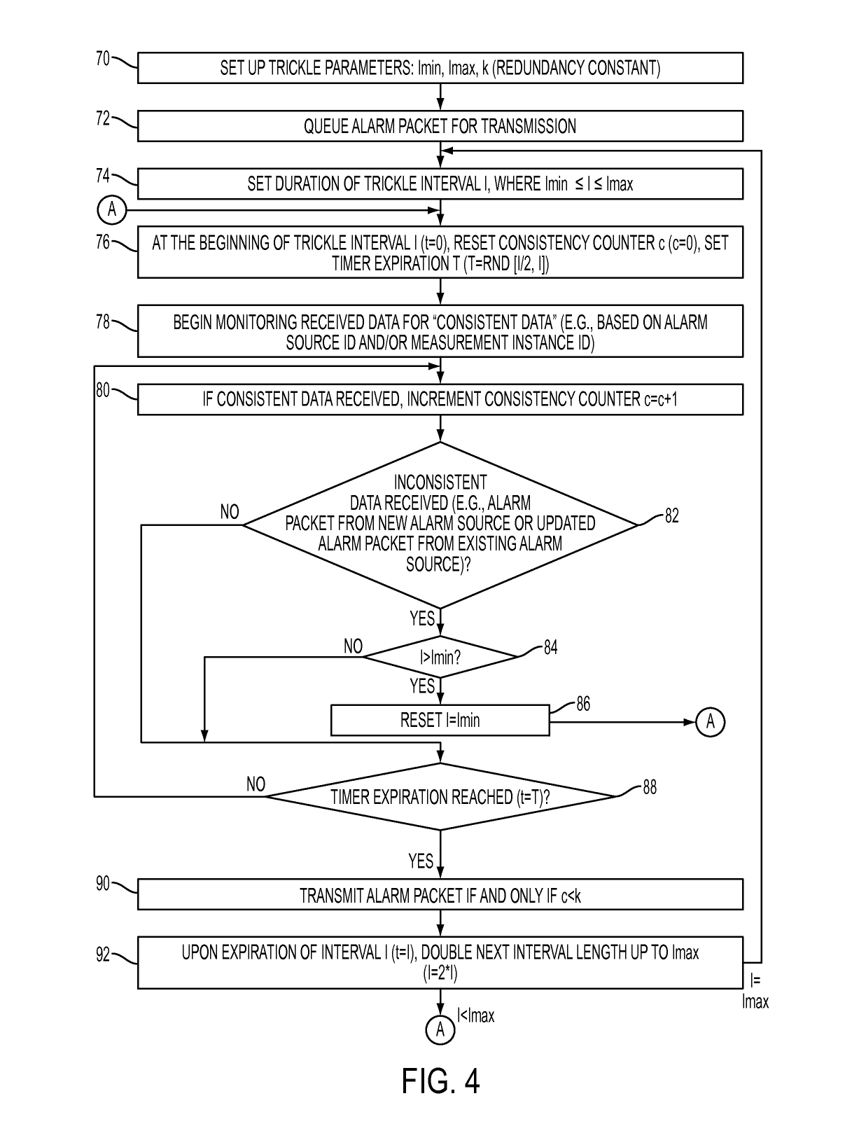

As described in further detail below with respect to FIGS. 3 and 4, the example embodiments enable propagation of alarm data to the wired destination 14′ based on disseminating the alarm data at an alarm level priority that is higher than any network-level priority of any wireless routing topology previously in use (as in FIG. 1A); hence, the alarm data can be disseminated on a “best effort” basis without regard to any routing topology based on suppressing transmission of any data packets that are not at the alarm level priority. The example embodiments also can minimize the occurrence of interference between two or more of the remaining network devices 12′ based on outputting the alarm packets using the MPL protocol employing the Trickle Algorithm as described in RFC 6206. Hence, the remaining network devices 12′ can propagate the alarm data on a “best effort” basis while minimizing the occurrence of interference or retransmission of unnecessarily redundant alarm packets.

FIG. 2 illustrates an example implementation of any one of the devices 12 (or 12′), 14 (or 14′), and 16 of FIG. 1, according to an example embodiment. Since the only difference between the devices 12 and 12′ (or 14 and 14′) is that the latter survives the disaster (FIG. 1B), the following description with respect to FIGS. 2, 3, and 4 are applicable to any of the devices 12 or 12′; hence, specific reference to 12′ is omitted to avoid redundancy.

Each of the network devices 12, 14, and/or 16 can include a device interface circuit 40, processor circuit 42, and a memory circuit 44. The device interface circuit 40 can include one or more distinct physical layer transceivers for communication with any one of the other devices 12, 14, and/or 16. For example, the device interface circuit 40 can include one or more wireless transceivers for transmitting on one or more IEEE 802.11 wireless data channels such as 2.4 GHz, 3.6 GHz, 4.9 GHz, 5 GHz, and/or 5.9 GHz bands (or other); the device interface circuit also can include a Bluetooth transceiver, etc. The processor circuit 42 can be configured for (i.e., physically constructed and arranged) executing any of the operations described herein, and the memory circuit 44 can be configured for storing any data or data packets as described herein.

Each network device 12 also can include one or more physical sensors 20 configured for outputting sensor data. Each sensor 20 can be configured for specifying sensor data as “alarm data” if the measured sensor data exceeds prescribed critical thresholds, for example dangerously high pressure level (indicating an explosion), high temperature level (indicating a fire), high carbon dioxide level or high carbon monoxide level (indicating life-threatening environmental conditions), etc.

Any of the disclosed circuits of the devices 12, 14, and/or 16 (including the device interface circuit 40, the processor circuit 42, the memory circuit 44, and their associated components) can be implemented in multiple forms. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit 42 such as a microprocessor circuit (not shown) and implemented using one or more integrated circuits, where execution of executable code stored in an internal memory circuit (e.g., within the memory circuit 44) causes the integrated circuit(s) implementing the processor circuit 42 to store application state variables in processor memory, creating an executable application resource (e.g., an application instance) that performs the operations of the circuit as described herein. Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. The memory circuit 44 can be implemented, for example, using a non-volatile memory such as a programmable read only memory (PROM) or an EPROM, and/or a volatile memory such as a DRAM, etc.

Further, any reference to “outputting a message” or “outputting a packet” (or the like) can be implemented based on creating the message/packet in the form of a data structure and storing that data structure in a non-transitory tangible memory medium in the disclosed apparatus (e.g., in a transmit buffer). Any reference to “outputting a message” or “outputting a packet” (or the like) also can include electrically transmitting (e.g., via wired electric current or wireless electric field, as appropriate) the message/packet stored in the non-transitory tangible memory medium to another network node via a communications medium (e.g., a wired or wireless link, as appropriate) (optical transmission also can be used, as appropriate). Similarly, any reference to “receiving a message” or “receiving a packet” (or the like) can be implemented based on the disclosed apparatus detecting the electrical (or optical) transmission of the message/packet on the communications medium, and storing the detected transmission as a data structure in a non-transitory tangible memory medium in the disclosed apparatus (e.g., in a receive buffer). Also note that the memory circuit 44 can be implemented dynamically by the processor circuit 42, for example based on memory address assignment and partitioning executed by the processor circuit 42.

FIG. 3 illustrates an example method in the network device of FIG. 1 for outputting alarm data at an alarm level priority that is higher than any network-level priority of any wireless routing topology, according to an example embodiment. FIG. 4 illustrates an example outputting the alarm data based on waiting a waiting interval of a random selected time interval to detect if the alarm data has already been transmitted a prescribed number of times, according to an example embodiment.

The operations described in FIGS. 3 and/or 4 can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit (e.g., 42 of FIG. 2) implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

In addition, the operations described with respect to any of the FIGS. 1-4 can be performed in any suitable order, or at least some of the operations in parallel. Execution of the operations as described herein is by way of illustration only; as such, the operations do not necessarily need to be executed by the machine-based hardware components as described herein; to the contrary, other machine-based hardware components can be used to execute the disclosed operations in any appropriate order, or at least some of the operations in parallel.

Referring to FIG. 3, the processor circuit in each network device 12 (within the network of FIG. 1A) can build in operation 50 a wireless network topology with the other network devices 12 and wired destinations 14 according to a prescribed routing protocol, for example RPL. Other wireless network topologies can be built among the wireless network devices 12, as appropriate. Upon establishment of the wireless network topology in FIG. 1A, each of the wireless network devices 12 of FIG. 1A can route data packets according to the routing protocol, where “control packets” (e.g., network management packets used to construct and maintain the wireless network topology) are granted the highest network-level priority, and other “non-control packets” (e.g., data packets carrying sensor data) are granted a lower priority.

Assume in operation 52 that the network topology is lost, for example based on a major network disruption due to a disaster as illustrated in FIG. 1B. At a minimum, the network topology can be lost if conditions exist that cause a loss of heartbeat messages, routing protocol update messages, etc., or some other critical event that results in the likely failure of unicast routing. In many instances the network disruption is not even detected by the remaining network nodes 12′, especially since the remaining network nodes 12′ may still be waiting for expiration of maintenance timers (e.g., for heartbeat messages, keepalive messages, etc.).

In fact, the initial detection of the disaster having caused the major network disruption can be completed by one of the remaining sensor nodes 12′ detecting in operation 54 emergency data from one of the attached physical sensors 20 of FIG. 2. For example, the processor circuit 42 of the remaining sensor node 12′ can determine that the sensor data from one of the attached physical sensors 20 exceeds a prescribed threshold associated with an emergency or life-threatening event. “Sensor data” is defined as data that quantifies a measurement by a physical sensor of a physical attribute. Numerous sensor types and associated threshold types can be used to detect a critical life-threatening event, for example: biometric sensors detecting heart rate, blood pressure, blood oxygen level, glucose level, etc.; image sensors indicating a substantial change from a prior stable condition (indicating a fire and/or destruction of a given room or area 24), audio data exceeding acceptable safety levels (representing, for example, failing machinery or sounds from an explosion, etc.), environmental data indicating the presence of a disaster (e.g., temperature data indicating a fire, dangerously high carbon monoxide or carbon dioxide levels, or dangerously high smog levels, etc.), or machine state (e.g., automatic deployment of fire extinguishers such as water-based extinguishers or halon suppression systems or equivalent, etc.).

The processor circuit 42 of the sensor node 12′ can generate in operation 54 an “alarm packet” (i.e., a data packet specifying alarm data generated by the sensor node 12′). The alarm packet can include a differentiating portion used to distinguish the alarm packet from other alarm packets, described below, and a non-differentiating portion (containing, for example, the sensor data as payload data). The differentiating portion can include metadata that distinguishes the alarm packet from other alarm packets, including for example alarm source identifier, measurement instance identifier, and/or sensor data type. Examples of alarm source identifier can include user badge identifier, sensor node identifier such as EUI-64 (Link Layer Media Access Controller) address, Internet protocol (IP) unicast address of the sensor node 12′, and/or location identifier specifying the relevant location of the sensor node 12′ (e.g., room identifier and/or grid identifier for an identifiable location 24, monitored machine identifier, etc.). Hence, depending on the alarm source identifier multiple copies of alarm messages from different sensor nodes within the same “location” may be deemed redundant, such that any sensor data from any sensor node 12′ in the same “location” is deemed the same sensor data for purposes described below with respect to FIG. 4. Examples of a measurement instance identifier can include a date and time stamp, a sequence identifier, frame number for a video or graphic image, etc. Sensor data type can specify the type of sensor that generated the data, for example biometric sensor, image sensor, audio sensor, environmental sensor, machine-specific sensor, etc.

Hence, the processor circuit 42 of the remaining sensor node 12′ can generate and output in operation 54 (via its corresponding device interface circuit 40) the alarm packet specifying an alarm level priority that is higher than any network-level priority of any routing protocol used by the lost network topology of FIG. 1A. As described in further detail below with respect to FIG. 4, the processor circuit 42 can retransmit the same alarm packet (or an updated alarm packet) at different transmission intervals until detecting retransmission by another forwarding node 12′. The sensor node 12′ also can transmit the alarm packet without explicitly specifying the alarm level priority, in which case the first forwarding node receiving the alarm packet can set the alarm level priority in response to detecting the alarm parameters in the alarm packet; in this case, the first forwarding node serves as an “ingress node” into the “ad hoc alarm dissemination network” established by the remaining forwarding nodes 12′ for emergency transport of the alarm packet between the sensor node and the remaining wired destination 14′.

The device interface circuit 40 of another of the remaining network devices 12′ (i.e., a forwarding node) can receive in operation 56 the data packet specifying the alarm data generated by the sensor node 12′. As described in further detail below with respect to FIG. 4, the processor circuit 42 of the forwarding node 12′ is configured for responding in operation 58 to the alarm packet by suspending any routing protocols of any previously-used routing topologies (as in operation 50), suppressing transmission of all other data packets, and initiating outputting of the alarm packet according to a MPL-Based Trickle Algorithm that is independent of any routing protocol or any routing topology. The sequence of forwarding the alarm packet via the remaining forwarding nodes 12′ is repeated in operations 56 and 58 until the alarm packet is received in operation 60 by a “sink node” or “egress node” of the “ad hoc alarm dissemination network” (e.g., the remaining wired destination 14′) that can forward in operation 62 the alarm packet via the LAN/WAN 18 to the destination device 16 for alarm processing (e.g., by an Administrator and/or a First Responder team).

FIG. 4 illustrates an example outputting of the alarm data in operation 58 of FIG. 3, based on waiting a waiting interval of a random selected time interval to detect if the alarm data has already been transmitted a prescribed number of times, according to an example embodiment. As described previously, the example embodiments can output the alarm packets at the alarm level priority using the MPL protocol (described in the above-cited Internet Draft by Hui et al.) employing the Trickle Algorithm as described in RFC 6206. As described in Hui et al. and RFC 6206, the processor circuit 42 in operation 70 can set up trickle parameters including a minimum interval size (Imin), a maximum interval size (Imax), and a redundancy constant “k” as defined in section 4.1 of RFC 6206. The trickle parameters can be set by an administrator in the network, for example based on the administrator device 16 dynamically downloading to each of the network devices 12 FIG. 1A the trickle parameters during initial installation of the wireless network devices 12 within the network 10. Typically each of the wireless network devices 12 of FIG. 1A also are associated within a prescribed secure authentication realm, ensuring that none of the network devices 12 could be compromised as a rogue node. The remaining operations are performed as part of outputting an alarm packet (operation 58) following the loss of the network topology (operation 52).

As described previously with respect to operation 56 of FIG. 3, one of the remaining forwarding nodes 12′ receives the alarm packet, and detects that the alarm packet has an alarm level priority higher than any network-level priority. In response to the processor circuit 42 queuing the alarm packet for transmission in operation 72 ahead of any other data packets having network-level priority or below, the processor circuit 42 in operation 74 sets an initial duration of the trickle interval “I”, where the trickle interval “I” is greater than or equal to the minimum interval size (Imin) and less than or equal to the maximum interval size (Imax). The processor circuit 42 also can monitor elapsed time within the current trickle interval “I” using a timer “t”. The processor circuit 42 at the beginning of the trickle interval (t=0) can reset in operation 76 a consistency counter “c” to zero (“c=0”) and set a timer expiration “T” to a randomly chosen value within the second half of the trickle interval “I” (“T=RND[I/2, I]”), described in further detail in section 4.2 of RFC 6206. As described below, collision avoidance is established based on the timer “t” progressing through different stages of the trickle interval “I”, namely the “waiting interval” during the first half of the trickle interval (t=[0, I/2], i.e., 0≦t≦I/2), followed by the transmission opportunity upon timer “t” reaching the timer expiration “T=RND [I/2, I]” (i.e., t=T), followed by the post transmission opportunity interval following the timer expiration until the end of the interval “t=[T, I]” (i.e., T≦t≦I).

The processor circuit 42 in operation 78 begins waiting during the “waiting interval” (t=[0, I/2], i.e., 0≦t≦I/2) that is the initial part of the randomly selected time interval “T” of the current trickle interval “I”. The processor circuit 42 begins monitoring at operation 78 for received alarm data that is “consistent” (i.e., the same alarm data); as described previously, whether received alarm data is “consistent data” (according to section 4.2 of RFC 6206) (i.e., the same alarm data or “redundant” alarm data) can be determined via different methods, as appropriate, including whether the alarm packets specify the same alarm source identifier, the same measurement instance identifier, and/or the same sensor data type. If the same alarm packet (or same alarm data) is received by the device interface circuit 40, the processor circuit 42 in operation 80 can increment the consistency counter “c” allocated for the particular alarm packet; as apparent from the foregoing, different consistency counters can be allocated for different alarm packets, as appropriate.

If in operation 82 “inconsistent data” is received (e.g., an alarm packet from a new alarm source and/or an updated alarm packet from an existing alarm source), and in operation 84 the existing trickle interval “I” is greater than the prescribed minimum interval “Imin”, the existing trickle interval “I” is reset to the prescribed minimum interval “Imin” in operation 86 and the trickle operations are repeated at operation 76 using the new minimum trickle interval.

If in operation 82 no inconsistent data is received representing an alarm packet from a new alarm source or an updated alarm packet from an existing alarm source, the processor circuit 42 checks in operation 88 whether the timer expiration has been reached. If the timer expiration has not been reached (i.e., t<T), the processor circuit 42 continues monitoring for consistent data and incrementing the consistency counter accordingly.

Upon expiration of the timer in operation 80, the processor circuit 42 checks in operation 90 whether the consistency counter “c” is less than the redundancy constant “k”, indicating a less than desirable number of redundant copies of the alarm packet have been received: the processor circuit 42 transmits the alarm packet in operation 90 if and only if the consistency counter “c” is less than the redundancy constant “k”. As apparent from the foregoing with respect to operations 80, 82, and 90, the differentiating portion (containing, for example, alarm source identifier, measurement instance identifier, and/or sensor data type, etc.) of a data packet enables redundant copies of the alarm packet to be suppressed if the number of redundant copies exceeds the redundancy constant “k”. Hence, the differentiating portion can enable data packets from two different sensor nodes to be suppressed (e.g., canceled out) if the data packets are deemed redundant (e.g., same source “location” based on alarm source identifier, same measurement instance based on measurement instance identifier, and/or same sensor data type) and exceeding the redundancy constant “k”.

Regardless of whether the alarm packet is transmitted, upon expiration of the current interval “t=I”, the processor circuit 42 in operation 92 doubles the next interval length “I=2*I” until the maximum interval has been reached.

As apparent from the foregoing, the outputting illustrated in FIG. 3 is executed by each remaining forwarding node 12′ that receives the alarm packet, independent and distinct from any of the other remaining forwarding nodes 12′. Hence, even if a number of the remaining forwarding nodes 12′ simultaneously receive an alarm packet for transmission, collision avoidance is established based on each of the remaining forwarding nodes 12′ responding to the received alarm packet by randomly choosing a trickle interval “I” within the range of the minimum interval (Imin) and the maximum interval (Imax), and randomly choosing within the chosen trickle interval “I” a timer expiration “T” within the second half of the trickle interval “I”.

According to example embodiments, data packets specifying alarm data generated by a sensor node (i.e. “alarm packets”) are output at an alarm level priority that is higher than any network-level priority of any wireless routing topology. Hence, alarm data can be disseminated among available network devices remaining after a critical event, even without the available network devices having detected that the prior network topology has been lost due to the critical event (e.g., explosion, fire, etc.). The alarm data also can be disseminated in a manner that avoids interference between neighboring network devices having received the same alarm data.

While the example embodiments in the present disclosure have been described in connection with what is presently considered to be the best mode for carrying out the subject matter specified in the appended claims, it is to be understood that the example embodiments are only illustrative, and are not to restrict the subject matter specified in the appended claims.

What is claimed is:

1. A method comprising:
receiving, by a network device, a data packet specifying alarm data generated by a sensor node; and
outputting, by the network device, the data packet at an alarm level priority that is higher than any network-level priority of any wireless routing topology.

2. The method of claim 1, wherein the outputting includes transmitting the data packet independent of any wireless routing protocol or the any wireless routing topology.

3. The method of claim 1, wherein the alarm data specifies that the alarm data is generated in response to the sensor node detecting a critical life-threatening event.

4. The method of claim 1, wherein the outputting includes:
waiting a waiting interval of a first randomly selected time interval within a prescribed interval range to detect if the alarm data has been transmitted a prescribed number of times; and
at expiration of the first randomly selected time interval, transmitting the alarm data if and only if the alarm data was transmitted less than the prescribed number of times.

5. The method of claim 4, wherein the outputting further includes resetting the first randomly selected time interval to within a prescribed minimum interval range, less than the prescribed interval range, in response to detecting a newer version of the alarm data generated by the sensor node.

6. The method of claim 1, further comprising suppressing transmission of any network-level priority data packet until transmission of the data packet at the alarm level priority.

7. The method of claim 1, wherein the outputting includes suspending use of any wireless routing protocol or any wireless routing topology in response to the alarm data, and multicasting the data packet at the alarm level priority, according to a prescribed trickle protocol.

8. The method of claim 1, wherein each data packet containing alarm data includes a differentiating portion for distinguishing data packets containing alarm data, the outputting including selectively suppressing a second received data packet specifying alarm data based on the corresponding differentiating portion.

9. An apparatus comprising:
a device interface circuit configured for receiving a data packet specifying alarm data generated by a sensor node; and
a processor circuit configured for controlling outputting of the data packet at an alarm level priority that is higher than any network-level priority of any wireless routing topology.

10. The apparatus of claim 9, wherein the processor circuit is configured for transmitting the data packet independent of any wireless routing protocol or the any wireless routing topology.

11. The apparatus of claim 9, wherein the alarm data specifies that the alarm data is generated in response to the sensor node detecting a critical life-threatening event.

12. The apparatus of claim 9, wherein the processor circuit is configured for:
waiting a waiting interval of a first randomly selected time interval within a prescribed interval range to detect if the alarm data has been transmitted a prescribed number of times; and
at expiration of the first randomly selected time interval, transmitting the alarm data if and only if the alarm data was transmitted less than the prescribed number of times.

13. The apparatus of claim 12, wherein the processor circuit is configured for resetting the first randomly selected time interval to within a prescribed minimum interval range, less than the prescribed interval range, in response to detecting a newer version of the alarm data generated by the sensor node.

14. The apparatus of claim 9, wherein the processor circuit is configured for suppressing transmission of any network-level priority data packet until transmission of the data packet at the alarm level priority.

15. The apparatus of claim 9, wherein the processor circuit is configured for suspending use of any wireless routing protocol or any wireless routing topology in response to the alarm data, and multicasting the data packet at the alarm level priority, according to a prescribed trickle protocol.

16. The apparatus of claim 9, wherein each data packet containing alarm data includes a differentiating portion for distinguishing data packets containing alarm data, the processor circuit configured for selectively suppressing a second received data packet specifying alarm data based on the corresponding differentiating portion.

17. Logic encoded in one or more non-transitory tangible media for execution by a machine and when executed by the machine operable for:
receiving a data packet specifying alarm data generated by a sensor node; and
outputting the data packet at an alarm level priority that is higher than any network-level priority of any wireless routing topology.

18. The logic of claim 17, wherein the outputting includes transmitting the data packet independent of any wireless routing protocol or the any wireless routing topology.

19. The logic of claim 17, wherein the alarm data specifies that the alarm data is generated in response to the sensor node detecting a critical life-threatening event.

20. The logic of claim 17, wherein the outputting includes:
waiting a waiting interval of a first randomly selected time interval within a prescribed interval range to detect if the alarm data has been transmitted a prescribed number of times; and
at expiration of the first randomly selected time interval, transmitting the alarm data if and only if the alarm data was transmitted less than the prescribed number of times.

21. The logic of claim 20, wherein the outputting further includes resetting the first randomly selected time interval to within a prescribed minimum interval range, less than the prescribed interval range, in response to detecting a newer version of the alarm data generated by the sensor node.

22. The logic of claim 17, further comprising suppressing transmission of any network-level priority data packet until transmission of the data packet at the alarm level priority.

23. The logic of claim 17, wherein the outputting includes suspending use of any wireless routing protocol or any wireless routing topology in response to the alarm data, and multicasting the data packet at the alarm level priority, according to a prescribed trickle protocol.

24. The logic of claim 17, wherein each data packet containing alarm data includes a differentiating portion for distinguishing data packets containing alarm data, the outputting including selectively suppressing a second received data packet specifying alarm data based on the corresponding differentiating portion.
